(19) United States
(12) Patent Application Publication
(10) Pub. No.: US 2023/0289241 A1
(43) Pub. Date: Sep. 14, 2023

(54) AUTOMATIC DATA PIPELINE GENERATION

(71) Applicant: Twitter, Inc., San Francisco, CA (US)

(72) Inventors: Pulkit Gupta, San Francisco, CA (US); Sunil Kumar Janardhanan, Pleasanton, CA (US); Kirill Shklovsky, Boston, MA (US); Robert Phamle, San Diego, CA (US); Amartya Datta Gupta, Holliston, MA (US)

(21) Appl. No.: 17/689,625

(22) Filed: Mar. 8, 2022

(51) Int. Cl. G06F 9/52; G06F 9/48

(52) U.S. Cl. CPC G06F 9/52; G06F 9/4881

(57) ABSTRACT

Methods, systems, and apparatus, including computer programs encoded on computer storage media, for generating a data processing pipeline. One of the methods includes receiving configuration data that identifies a) input data to be processed by a pipeline processing system that includes one or more subsystems and b) one or more data processing parameters; accessing two or more templates, wherein each template includes a set of data processing stages; selecting, from the two or more templates, one or more specific templates that have a plurality of data processing stages; generating the data processing pipeline that i) includes the plurality of data processing stages and ii) indicates one or more processing steps for the respective subsystem to perform on respective data; and causing the one or more subsystems to perform the processing steps to generate output data from the input data according to the one or more data processing parameters.

### BACKGROUND

This specification relates to automatically generating data processing pipelines.

Client devices can send requests to servers. The requests can be for different tasks. For example, one request can be annotating or labeling a set of data samples. In another example, the request can be validating a machine learning model.

### SUMMARY

Sometimes multiple different client devices can create data processing pipelines for corresponding data. Some of the data processing pipelines can have one or more overlapping stages. In some examples, creation of a data processing pipeline can be difficult, error prone, or both.

To improve data processing pipeline creation, a pipeline generation system can receive task requests from different client devices. For example, the system can receive user input that identifies a task request for labeling a set of data samples. As part of the task request, the system can receive configuration data from the client device. The configuration data can identify input data, e.g., the data samples to be labeled, and one or more parameters that indicate the specific requirements or instructions for the task request, e.g., what the required output should look like, how many times the labeling of data samples should be executed, and any other requirements.

The system can automatically generate a data processing pipeline for each task request. The data processing pipeline can include a set of data processing stages. Each stage can correspond to a sub-task and include the processing steps for the sub-task. For example, the data processing pipeline for labeling a set of data samples can include downloading or retrieving the data samples, validating the data samples, sending the data samples to labeling entities, receiving the generated labels, and returning the output data including the labels. At least some of the stages can be performed by different data processing systems.

The system can generate the data processing pipeline automatically using templates. The use of the templates can enable the system to generate data processing pipelines more consistently, more efficiently, or both. For instance, by using a template, the system can use memory more efficiently when creating a data processing pipeline.

After generating the data processing pipeline, the system can cause one or more other systems to process the data processing pipeline. The execution of the data processing pipeline can cause other systems to process the input data and generate output data according to the one or more parameters. At least one of the other systems can return the output data, e.g., generated labels for the data samples, to the client device.

In general, one aspect of the subject matter described in this specification can be embodied in methods that include the actions of receiving configuration data that identifies a) input data to be processed by a pipeline processing system that includes one or more subsystems and b) one or more data processing parameters according to which the pipeline processing system will process the input data; accessing two or more templates, wherein each template includes a set of data processing stages that each define a data type and one or more data processing steps for a respective subsystem, from the one or more subsystems, to perform on respective data of the data type; after receiving the configuration data, selecting, from the two or more templates and using the configuration data, one or more specific templates that have a plurality of data processing stages, the one or more specific templates are selected according to the configuration data; generating, using the configuration data and the one or more specific templates, the data processing pipeline, the data processing pipeline is a pipeline specification that i) includes the plurality of data processing stages in an order selected using the configuration data and ii) indicates, for at least some of the stages in the plurality of data processing stages, one or more processing steps for the respective subsystem from the one or more subsystems of the pipeline processing system to perform on respective data, associated with the input data, of the data type; and causing, using the data processing pipeline, the one or more subsystems of the pipeline processing system to perform the processing steps defined by the data processing pipeline to generate the output data from the input data according to the one or more data processing parameters by sending one or more messages to the one or more subsystems.

Other embodiments of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations, receiving the configuration data that identifies the one or more data processing parameters can include receiving a parameter set identifier for the one or more data processing parameters. In some implementations, causing the one or more subsystems of the pipeline processing system to perform the processing steps defined by the data processing pipeline can include sending the parameter set identifier to an initial subsystem from the one or more other subsystems in the data processing pipeline.

In some implementations, the method can include selecting the order for the plurality of data processing stages using an input data type and an output data type identified by the configuration data.

In some implementations, receiving the configuration data that identifies the input data can include receiving one or more query parameters that, when run on a database, return the input data.

In some implementations, accessing the templates can include retrieving, from memory, a data processing pipeline template that includes one or more variables. Generating the data processing pipeline can include configuring the one or more variables included in the data processing pipeline template using the configuration data to generate the data processing pipeline.

In some implementations, selecting the templates can include selecting, from a plurality of data processing pipeline templates and using the configuration data, a single data processing pipeline template that defines the entire data processing pipeline. Generating the data processing pipeline can include configuring the single data processing pipeline template using the configuration data to generate the entire data processing pipeline.

In some implementations, selecting the templates can include selecting, from two or more data processing pipeline stages and using the configuration data, one or more data processing pipeline stages that together form the data processing pipeline. In some implementations, receiving the configuration data can include receiving the configuration data that identifies the input data, identifies the one or more data processing parameters, and identifies a machine learning model. Selecting the one or more data processing pipeline stages can include: selecting one or more stages for the data processing pipeline that provide, to the machine learning model, the input data, compare output data of the machine learning model with data generated by one of the one or more other systems, and generate metrics about the machine learning model's processing of the input data using a result of the comparison.

In some implementations, generating the data processing pipeline can include generating the data processing pipeline that includes at least one stage that will present a user interface to enable a user to select a user interface element.

In some implementations, selecting the templates can include selecting, using data other than the configuration data, the templates. In some implementations, selecting the templates using data other than the configuration data can include selecting the templates that includes at least one data validation stage that validates the input data for the one or more data processing parameters.

In some implementations, receiving the configuration data for the data processing pipeline can include receiving the configuration data for the data processing pipeline that will create one or more labels for the input data given the one or more data processing parameters; and causing the one or more subsystems of the pipeline processing system to perform the processing steps defined by the data processing pipeline can include: determining, using a type of the configuration data, whether the system has a machine learning model that was trained to create labels for the input data that includes a plurality of sets; in response to determining that the system has a machine learning model that was trained to create labels for the input data, providing, to the machine learning model, the input data to cause the machine learning model to create, for each input data set from the plurality of sets, a label and a confidence value that indicates a likelihood that the label is an accurate label for the corresponding input data set; receiving, from the machine learning model, labeled data that includes, for each input data set, the label and the confidence value; selecting, from the plurality of sets, one or more sets of the input data that have corresponding confidence values that do not satisfy a threshold confidence value; and providing, to a first subsystem from the one or more subsystems, the one or more sets of the input data that have corresponding confidence values that do not satisfy the threshold confidence value to cause the first subsystem to create labels for the one or more sets of the input data.

In some implementations, receiving the configuration data can include receiving the configuration data that identifies the input data, identifies the one or more data processing parameters, and identifies one or more types of subsystems for the one or more subsystems that will process the input data; and causing the one or more subsystems of the pipeline processing system to perform the processing steps defined by the data processing pipeline can include: selecting, from a plurality of subsystems and using the one or more types of subsystems, the one or more subsystems that will process the input data.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various embodiments and may result in one or more of the following advantages. In some implementations, an automatic pipeline generation system can automatically generate data processing pipelines for user requests with fewer manual operations than other systems. The automatic pipeline generation system can reduce requested input from a user, reduce errors introduced by manual operations, increase data processing efficiency, improve user experience, or a combination of two or more of these. For example, the automatic pipeline generation system does not require users to have engineering knowledge for designing data pipelines.

In some implementations, the automatic pipeline generation system can be a centralized system that manages different task requests from a set of different users. The automatic pipeline generation system can automatically generate different data processing pipelines for the different task requests using templates, enabling reuse of data, reduced errors, or both. The automatic pipeline generation system can reuse the templates for different task requests, reduce duplicate work, reduce duplicate computation, and improve resource usage efficiency and data processing efficiency.

In some implementations, the automatic pipeline generation system can store both data samples and labels centrally, in compliance with privacy and data protection (PDP) practice and make the data samples and labels easily discoverable for reuse. The automatic pipeline generation system can provide a user, e.g., customer, agnostic functionality like label quality measurement and PDP compliance while requiring minimal additional effort from users.

In some implementations, the automatic pipeline generation system can provide real-time status tracking and other task management capabilities. Some task management capabilities can include providing remaining budget and chargeback to users, enabling easy trade-off discussion between cost and output quality of the task, or both.

In some implementations, the automatic pipeline generation system can allow administrators to manage, troubleshoot, or both, in-flight tasks. For example, the real-time progress of the execution of one or more jobs included in a task can be illustrated in a graphical user interface. An administrator can monitor the execution process of the jobs and manage the jobs by interacting with the graphical user interface.

In some implementations, the automatic pipeline generation system can avoid lock-in with certain data processing systems. For instance, if there is a need to replace a data processing system with another one, the pipeline generation system can integrate with the new data processing system while keeping the user experience stable and unchanged.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example computing environment for automatic data processing pipeline generation.

FIG. 2 is an example of a data processing pipeline.

FIG. 3 is a flow diagram of an example process for automatic data processing pipeline generation.

Like reference numbers and designations in the various drawings indicate like elements.

### DETAILED DESCRIPTION

Data processing and analysis can be used by users for different tasks. For example, a machine learning engineer working on a new machine learning model may need to train the new machine learning model with a set of labeled training data. A data scientist analyzing misinformation may need to have a set of input data to be labeled to determine whether any of the input data includes misinformation.

Instead of having the machine learning engineer or the data scientist manually build a pipeline for a data processing task, an automatic pipeline generation system can set up data processing pipelines, e.g., with reduced interaction with the users. For example, the automatic pipeline generation system can receive the task requests, including input data and parameters, from client devices, generate the data processing pipelines for different tasks that process the input data according to the parameters, and cause a pipeline processing system to process the input data and generate the output data to the client devices.

The data processing pipeline can be a pipeline specification that defines multiple processing stages. A system or subsystem that receives a data processing pipeline, or a portion of the data processing pipeline, can process processing steps defined by respective processing stages.

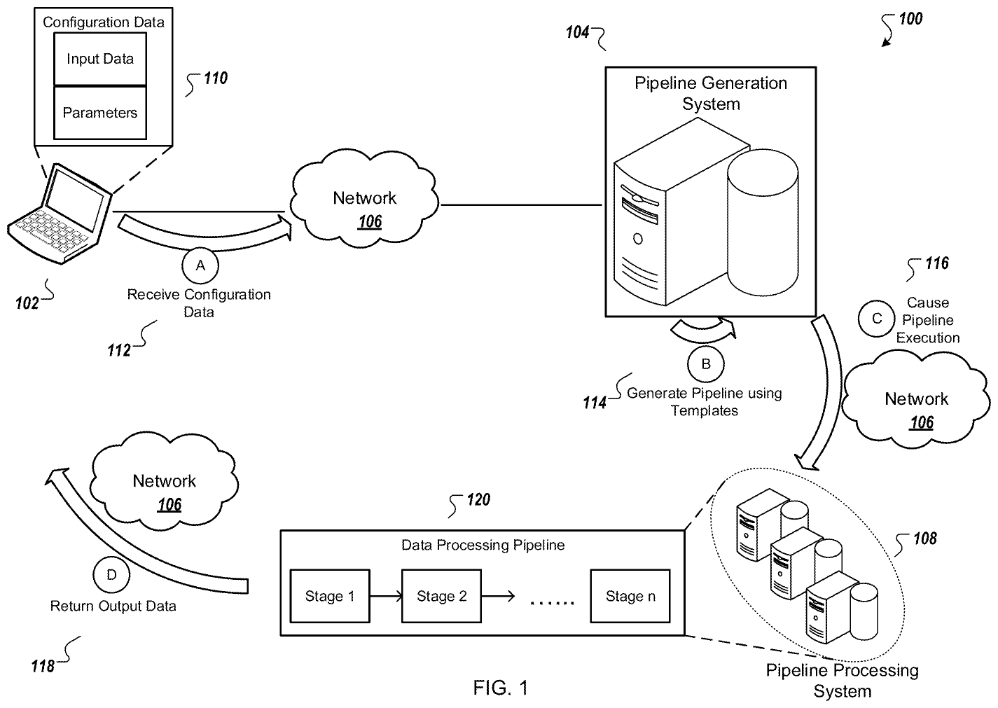

FIG. 1 depicts an example computing environment 100 for automatic data processing pipeline generation. The computing environment 100 can include one or more client devices 102 and a pipeline generation system 104 including one or more computers, e.g., servers, that are connected over a network 106. Furthermore, the pipeline generation system 104 can connect with a pipeline processing system 108 including one or more subsystems over the network 106 or any other networks.

The pipeline generation system 104 can receive one or more task requests from one or more client device 102. For example, the task request can be labeling a set of data samples. The task request can include configuration data 110 from the client devices 102. The configuration data 110 can identify input data and one or more data processing parameters for processing the input data. For instance, the input data can be a set of data samples to be labeled. The one or more processing parameters can be parameters used for processing the input data.

The input data can be any appropriate type of input data. For example, the input data can include images, messages, documents, video, audio, or any other form of data.

In step A 112, the pipeline generation system 104 can receive the configuration data 110 from the client devices 102 over the network 106. In some examples, as part of step A 112, the pipeline generation system 104 can receive other data for the task.

In step B 114, the pipeline generation system 104 can generate data processing pipelines 120 using templates for the task requests. The templates can include pipeline templates, template stages, or both. In some implementations, a data processing pipeline 120 can include a set of data processing stages. Each stage can correspond to a sub-task and include the processing steps for the sub-task. For example, the data processing pipeline for labeling input data, e.g., the set of data samples, can include five stages. The five stages can include downloading or retrieving the data samples, validating the data samples, sending the data samples to labeling entities, receiving the generated labels, and returning the output data including the labels. A pipeline template for this labeling input data pipeline can include each of the five data processing stages.

In some implementations, the data processing pipelines for different task requests can be the same or can have one or more overlapping stages. The pipeline generation system 104 can reuse the templates for the different task requests. For example, the templates can include pipeline templates, template stages, and default stages. In some implementations, different task requests can correspond to the same data processing pipeline. The pipeline generation system 104 can reuse the pipeline templates, including a set of predetermined stages, for different task requests that request the same or similar task to be performed, and generate new pipelines directly from the pipeline templates without re-computing each pipeline separately for each task request.

In some implementations, while the data processing pipelines may not be the same for different task requests, there are some overlapping stages. For example, different pipelines can share some common stages. The pipeline generation system 104 can reuse the template stages for overlapping stages of different pipelines of different task requests.

In some implementations, the pipeline generation system 104 can generate pipelines including default stages. For example, for certain task requests, one or more stages are automatically included as default stages without further computation. For instance, a default stage can be a validation stage that validates the input data for the one or more data processing parameters. As a result, by using the default data processing stages, the pipeline generation system 104 can reduce duplicate work, save memory, and improve resource usage efficiency and data processing efficiency.

In step C 116, the pipeline generation system 104 can cause one or more subsystems of the pipeline processing system 108 to process the input data. After generating the data processing pipeline 120, the pipeline generation system 104 can communicate with the pipeline processing system 108 over the network 106 to cause the pipeline processing system 108 to process the input data using the generated data processing pipeline 120. In some implementations, the pipeline processing system 108 can include one or more subsystems. The different stages included in the data processing pipeline 120 can be processed by different subsystems of the pipeline processing system 108.

In some implementations, the data processing parameters included in the configuration data 110 can include a parameter set identifier. The pipeline generation system 104 can send the parameter set identifier to an initial subsystem of the one or more subsystems of the pipeline processing system 108 in the data processing pipeline. The parameter set identifier can identify a task guideline document that includes the one or more parameters for processing the input data. When the pipeline processing systems 108 includes one or more subsystems that require human input, e.g., human-in-the-loop systems, the task guideline document can indicate one or more steps for a person to perform as part of the data processing pipeline 120.

The pipeline processing system 108 can process the different stages of the data processing pipeline 120. For example, the pipeline processing system 108 can process the input data, according to the one or more data processing parameters obtained from the parameter set identifier, to generate output data.

The data processing pipeline 120 can include any appropriate type of stages that are processed in any appropriate manner. In some implementations, the data processing pipeline 120 can include some stages that can be processed in a sequential manner. For example, processing of one stage is before processing of another stage. In some implementations, some of the stages can be processed in a parallel manner. For example, processing of one stage, e.g., stage 2, can be concurrently, or substantially concurrently, with processing of another stage.

In step D 118, the pipeline processing system 108 can return the output data to the client devices 102 over one or more networks 106. In some implementations, the pipeline processing system 108 can return the output data to the pipeline generation system 104. The pipeline generation system 104 can send the output to the client device 102.

The steps A-D can be performed in any appropriate order. In some implementations, steps A-D can be performed in sequence. In some implementations, steps A-D can be performed in parallel or partially in parallel. For example, assuming a data processing pipeline includes five stages, while the pipeline generation system 104 is generating the last stage, e.g., stage 5, in step B of generating the data processing pipeline, the pipeline generation system 104 can cause some of the earlier stages, e.g., stage 2, to be processed in step C.

The one or more user devices 102 can be an example of a system implemented as computer programs on one or more computers in one or more locations, in which the systems, components, and techniques described in this specification are implemented. The user devices 102 may include personal computers, mobile communication devices, and other devices that can send and receive data over a network 106. The network 106, such as a local area network (“LAN”), wide area network (“WAN”), the Internet, or a combination thereof, connects the user devices 102, the computers of the pipeline generation system 104, and the systems of the pipeline processing systems 108.

The one or more computers of the pipeline generation system 104, the one or more subsystems of the pipeline processing system 108, or both, may use a single server computer or multiple server computers operating in conjunction with one another, including, for example, a set of remote computers deployed as a cloud computing service.

The pipeline generation system 104 including one or more computers, the pipeline processing system 108 including one or more subsystems, or both, can include several different functional components, including a template component and a pipeline creation component, or a combination of these, can include one or more data processing apparatuses. For instance, each of the template component and the pipeline creation component can include one or more data processors and instructions that cause the one or more data processors to perform the operations discussed herein.

The various functional components of the pipeline generation system 104, the pipeline processing system 108, or both, may be installed on one or more computers as separate functional components or as different modules of a same functional component. For example, the template component and the pipeline creation component of the pipeline generation system 104 can be implemented as computer programs installed on one or more computers in one or more locations that are coupled to each through a network. In cloud-based systems for example, these components can be implemented by individual computing nodes of a distributed computing system.

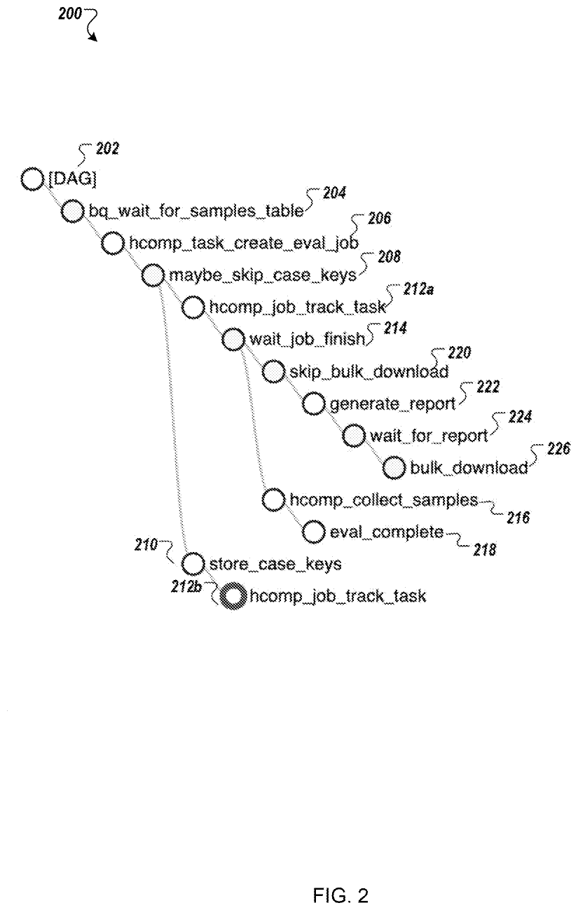

FIG. 2 is an example of a data processing pipeline 200. In some implementations, the data processing pipeline 200 can be in the form of a directed acyclic graph (DAG). Each node in the DAG can represent a data processing stage, and each directed edge can indicate the order of the data processing stages.

For example, the data processing pipeline 200 can be created for a data labeling task. The data processing pipeline 200 can be used for any other tasks and a data processing pipeline 200 can have any other appropriate stages.

The data processing pipeline 200 can include a first stage of “waiting for samples tables” 204. The samples tables can include the input data to be processed or labeled. After the first stage, the next stage can be “creating an evaluation job” 206 for the task, which can be creating a data labeling job with a data labeling platform. The creation of the data labeling job can include invoking a task identifier (ID) that is created on the data labeling platform.

The next stage can be an optional stage for “skipping keys” 208 for authentication. The next stage can be a stage for “storing keys” 210. Depending on whether the task requires a user to provide keys for authentication, the data processing pipeline 200 can have different branches for different scenarios. The next stage can be “tracking job progress” 212a, 212b in both branches for either “skipping keys” or “storing keys.”

In some implementations, the stage of “tracking job progress” 212a, 212b can include generating a graphical user interface (GUI) that illustrate the progress of the data labeling job on the data labeling platform in real time. An administrative user can monitor the real-time progress of the data labeling job and manage the job by interacting with the GUI. In some examples, the administrative user can troubleshoot the in-flight task based on the real-time process to trace and correct faults occurred in the data labeling job.

The next stage can be “waiting for job to finish” 214 based on the tracking status of the data-labeling job. In some example, after the job is finished, there can be two branches included in the data processing pipeline 200: a branch for collecting samples, and a branch for generating reports. The branch for collecting samples and the branch for generating reports can be processed in parallel or in serial. In some examples, one or more subsystems processing the input data using the data processing pipeline 200 only process one of the two branches.

In the branch for collecting samples, the next stage can be “collecting samples” 216 that collect the labeled samples or the output of the data labeling job. The next stage can be “evaluation job completed” 218 that indicates that the data labeling job is completed on the data labeling platform.

In the branch for generating reports, a stage for “skipping bulk downloading” 220 can be included following the stage of “waiting for job to finish” 214. The next stage can be “generating report” 222 can be included after the data labeling job is finished. The next stage can be “waiting for the report” 224. The following stage can be “bulk downloading” 226 that downloads the report and any other relevant information of the task.

In some implementations, the report can include financial information including remaining budget and chargeback to users. In some implementations, for each task request from the client device, there is a charge for the service provided to satisfy the task request. The report can include the charge information for the task request. In some examples, the report can include the cost for services of different levels. For instance, the data labeling on the data labeling platform can include two levels: expert labeling and non-expert labeling. The expert labeling can be more expensive with higher accuracy. The non-expert labeling can be less expensive with lower accuracy. Such information can enable trade-off analysis between cost and output quality of the task. In some implementations, the report can be displayed in a graphical user interface that includes the financial information and one or more user interfaces for managing the task. For example, a user can select a percentage of the input data for expert labeling and the rest for non-expert labeling based on actual demand, financial situation, or both. The report can include information related to the service provided, such as the amount of input data that has been labeled, the percentage of the input data for expert labeling and non-expert labeling, and the cost respectively.

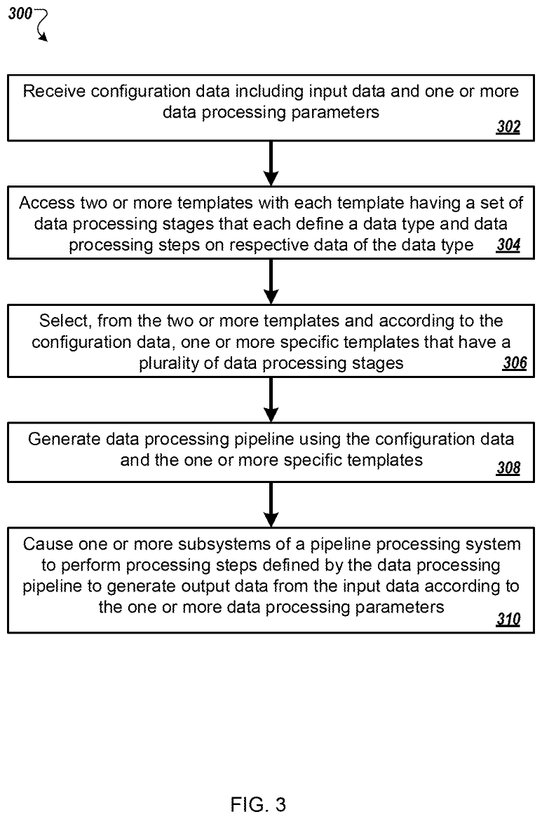

FIG. 3 is a flow diagram of an example process 300 for automatic data processing pipeline generation. For example, the process 300 can be used by the pipeline generation system 104 from the computing environment 100.

At step 302, the pipeline generation system receives configuration data that identifies the input data to be processed by a pipeline processing system that includes one or more subsystems, and the one or more data processing parameters according to which the pipeline processing system will process the input data. For example, the pipeline generation system can receive the one or more task requests. A task request can include the configuration data that identifies the input data and the one or more data processing parameters.

A data processing pipeline including one or more other systems, such as the one or more subsystems in the pipeline processing system, can process the input data to generate output data according to the one or more data processing parameters. For example, the task request can be labeling a set of data samples. The input data can be the set of data samples to be labeled. The one or more data processing parameters can be parameters for labeling the input data. The process of labeling the set of data samples can be implemented in a data processing pipeline, where one or more subsystems of the pipeline processing system can process one or more stages of the data processing pipeline.

In some implementations, the pipeline generation system can receive the input data identified by the configuration data directly or indirectly from a corresponding requesting client device. In some examples, the pipeline generation system can receive the input data directly, e.g., by receiving a table or other data that includes the input data. In some examples, the pipeline generation system can receive the input data indirectly, e.g., by receiving configuration data that identifies a location at which the input data is stored, and the pipeline generation system can obtain the input data from the location of the input data. For instance, the configuration data can identify a file path of the input data, or a Uniform Resource Locator (URL) of the input data.

In some implementations, the input data can be stored in any appropriate location. For example, the input data can be located in the client device. In some examples, the input data can be located in other systems, such as a cloud system.

In some examples, the pipeline generation system can receive configuration data that include one or more query parameters that, when run on a database, return the input data. For instance, the configuration data can include one or more parameters for a Structured Query Language (SQL) request, e.g., a SQL SELECT statement, that, when executed based on the one or more parameters, returns a result set of records from one or more databases. The returned result set can be the input data, e.g., the data samples to be labeled. By using the query parameters, or configuration data that identifies the input data location, to obtain the input data, the processing time and the memory storage requirements can be reduced, because there is no need to duplicate the data internally.

The one or more data processing parameters in the configuration data can indicate the specific requirements or instructions of the task request, e.g., how the input data should be processed, what the required output should look like, how many times the labeling of data samples should be executed, and any other requirements. For example, the one or more data processing parameters can indicate the type of outputs, such as topics associated with the input data, or a sentiment status associated with the input data, e.g., positive or negative. In some examples, the one or more data processing parameters can indicate whether the task request should be performed in a recurring fashion, e.g., periodically executed; or in an ad hoc fashion, e.g., executed once. In some examples, the one or more processing parameters can indicate specific requirements for privacy and data protection compliance.

In some implementations, receiving the one or more data processing parameters can include receiving a parameter set identifier for the one or more data processing parameters. For example, the parameter set identifier can identify a task guideline document corresponding to the task, e.g., the data labeling task. The task guideline document can include the one or more parameters for processing the input data.

At step 304, the pipeline generation system can access two or more templates. Each template can include a set of data processing stages that each define a data type and one or more data processing steps for a respective subsystem, from the pipeline processing system, to perform on respective data of the data type. Various ones of the data processing stages can be for performing different processing steps on different types of input data. By maintaining the two or more templates, the pipeline generation system can automatically select a first subset of the two or more templates for the configuration data which first subset is different than a second subset that would be selected for different configuration data.

In some implementations, the two or more templates can be stored in a memory. The pipeline generation system can access the two or more templates from the memory. Each template can include a set of data processing stages. Each data processing stage can define a data type and one or more data processing steps on respective data of the data type. For example, each data processing stage can correspond to one or more functions in one or more programs that perform the one or more data processing steps. In some examples, functions can perform the corresponding data processing steps.

The function can take input from a previous stage. The input from the previous stage is of the particular data type required as input by the current stage. A subsystem from the pipeline processing system can execute the function to perform the one or more data processing steps on the input of the particular data type.

When a stage is an input stage, the particular data type can be required as input from an input source. The input source can be any appropriate type of input source, such as a database.

At step 306, the pipeline generation system can automatically select, from the two or more templates and using the configuration data, one or more specific templates that have a plurality of data processing stages according to the configuration data. For instance, the pipeline generation system selects a subset of the two or more templates as the one or more specific templates.

In some implementations, the pipeline generation system can generate the data processing pipelines using templates. After receiving the configuration data for a task request, the pipeline generation system can select, from the two or more templates and using the configuration data, one or more specific templates that have a plurality of data processing stages. The plurality of data processing stages that can form the data processing pipeline of the task request. In some implementations, the plurality of data processing stages can include one stage or more than one stage. At least some of stages can indicate one or more data processing steps for subsystems in the pipeline processing system to perform.

In some implementations, instead of directly using only the configuration data to select the one or more specific templates that have the plurality of data processing stages, the pipeline generation system can automatically select the data processing stages for a data processing pipeline. For example, the data generation system can add templates with additional stages or remove existing stages as needed from a first template that includes multiple stages, using analysis of the configuration data to adjust the first template specific to the configuration data. For example, a task request can request a set of user data to be labeled. The pipeline generation system can analyze the configuration data for the task request and select a first subset of the two or more templates. The pipeline generation system can analyze the user data and determine that the user data includes sensitive information. In response, the pipeline generation system can automatically add an additional template, to the first subset, which additional template is for an additional stage for desensitizing the user data.

In some examples, the templates can include pipeline templates, e.g., that identify multiple stages in a pipeline, template stages, default stages, or a combination of these. The default stages can be specific to a particular task, a particular type of input data, a particular type of output data, or a combination of these. In some examples, a default stage can be for all pipelines.

Selecting the one or more specific templates can include selecting a pipeline template, selecting one or more template stages, selecting one or more default stages, or a combination of these. Selecting the one or more specific templates can include selecting the specific templates using the configuration data or using data other than the configuration data.

In some implementations, selecting the one or more specific templates can include retrieving a data processing pipeline template from memory. For example, the memory can include a set of pipeline templates. Each pipeline template can include a set of predetermined stages. For instance, a pipeline template can be a pipeline for labeling a set of messages in English to indicate whether a message is associated with positive sentiment or negative sentiment. If the pipeline generation system receives a new task request requesting the same task to be performed on a set of new English messages, the pipeline generation system can use the pipeline template to generate a new pipeline that has the same predetermined stages of the pipeline template.

As a result, the pipeline generation system can reuse the pipeline templates for different task requests that request the same or similar task to be performed, and generate new pipelines directly from the pipeline templates without re-computing each pipeline separately for each task request. Thus, the pipeline generation system can reduce energy usage, time required to create a pipeline, memory usage, errors, or a combination of two or more of these. In some examples, as a result of using the templates, the pipeline generation system can improve consistency, efficiency, or both.

In some implementations, selecting the one or more specific templates can include accessing the templates using the configuration data. For example, the configuration data can indicate how the input data should be processed and what the output should look like. The pipeline generation system can use the configuration data, e.g., data referenced by the configuration data such as input data or a task type, to select the corresponding data processing pipeline.

In some implementations, selecting the one or more specific templates can include selecting, from a set of data processing pipeline templates and using the configuration data, a data processing pipeline template that defines the data processing pipeline. As discussed above, there can be a set of pipeline templates stored in the memory. Each pipeline template can be for a particular task. When the pipeline generation system receives configuration data, the pipeline generation system can determine the type of task requested by the client device, and select a data processing pipeline template, from the set of pipeline templates, that is corresponding to the requested task. The selected pipeline template can define the data processing stages for the particular task request. For example, the pipeline generation system can generate a new pipeline that has the same predetermined stages of the selected pipeline template. Some example task types described above include labeling a set of data samples, and evaluating an accuracy of a machine learning model. A pipeline generation system can use any other appropriate task type.

In some implementations, selecting the one or more specific templates can include selecting, from two or more data processing pipeline stages and using the configuration data, one or more data processing pipeline stages that together form the data processing pipeline. The data processing pipeline stages can include one or more default data processing pipeline stages. In some examples, in addition to the pipeline templates stored in the memory, the pipeline generation system can store multiple template stages in the memory. Compared to the pipeline templates that include a set of predetermined stages, each template stage can correspond to a single stage. For example, one template stage can include steps for downloading data sets from a cloud service. Another template stage can include steps for checking privacy and data protection compliance. The pipeline generation system can receive the configuration data of a task request, and determine what sub-tasks are needed for the task request based on the configuration data. The pipeline generation system can select one or more template stages for the sub-tasks. The pipeline generation system can generate one or more stages using the template stages. The generated one or more stages can together form the data processing pipeline for the task request.

In some implementations, the pipeline generation system can select the one or more specific templates using data other than the configuration data. For example, the templates can include default stages that are used by the pipeline generation system. For instance, a default stage can be a validation stage that validates the input data for the one or more data processing parameters. After receiving the configuration data, the pipeline generation system can automatically perform a default validation stage that validates the input data, and determines whether the input data is complete and appropriate for the task requirement indicated by the one or more processing parameters.

In some implementations, the automatic pipeline generation system can be a centralized system that manages different task requests from a set of different users. By using templates, including pipeline templates, template stages, and default stages, the pipeline generation system can automatically generate different data processing pipelines for the different task requests, enabling reuse of data, reduced errors, reducing duplicate work, improving resource usage efficiency and data processing efficiency, or a combination of these.

At step 308, the pipeline generation system can generate, using the configuration data and the one or more specific templates, the data processing pipeline that i) includes the plurality of data processing stages in an order selected using the configuration data and ii) indicates, for at least some of the stages in the plurality of data processing stages, one or more processing steps for a subsystem in the pipeline processing system to perform on respective data, associated with the input data, of the data type.

The pipeline generation system can generate the data processing pipeline automatically with fewer manual operations than other systems. The automatic pipeline generation system can reduce requested input from a user, reduce errors introduced by manual operations, increase data processing efficiency, improve user experience, or a combination of two or more of these.

In some implementations, the generated data processing pipeline can include the plurality of data processing stages in an order selected using the configuration data. Each stage can correspond to a sub-task and include one or more processing steps for the sub-task. At least some of the stages in the plurality of data processing stages are for subsystems in the pipeline processing system to perform on respective data, associated with the input data, of the data type. The data associated with the input data can be data generated from the input data in one or more data processing stages.

The pipeline generation system can select the order for the plurality of data processing stages using an input data type, an output data type, or both, identified by the configuration data. For example, configuration data can indicate that the input data type is text messages, the output data type is labels indicating sentiment status of the text messages. Using the configuration data, the pipeline generation system can generate a data processing pipeline that include five stages. The five stages can be in a particular order. For instance, the five ordered stages can include downloading or retrieving the data samples, validating the data samples, sending the data samples to labeling entities, receiving the generated labels, and returning the output data including the labels. When the data processing pipeline includes five stages, five systems can process steps for the corresponding stages in the pipeline.

In some implementations, each stage in the plurality of ordered data processing stages can process respective data, associated with the input data, that is of a stage data type. For example, the first stage can process the input data received from the client device, and output data in a certain data type. The second stage can receive the output data from the first stage and generate output data to be processed by the third stage. A current stage can process the output data from a previous stage. The output data from the previous stage is of a data type that matches the data type defined in the current stage. In the first stage, the data type of the input data received from the client device matches the data type defined in the first stage.

In some implementations, after selecting the data processing pipeline template, the pipeline generation system can generate the data processing pipeline by configuring the data processing pipeline template using configuration data. For example, the pipeline template can include a set of predetermined stages. Each stage can include one or more processing steps for completing the sub-task of the stage. In some implementations, the one or more processing steps can be realized in a function in program. The function can be configured by setting values of one or more variables that are used by the function using the configuration data. The configuration data can include the values of the variables. The pipeline generation system can configure the data processing pipeline template by using the configuration data to set the values of the variables that are used in different functions of the data processing pipeline template.

In some implementations, the data processing pipelines for different task requests can have one or more overlapping stages. For example, a task request can be evaluating an existing machine learning model that is used for labeling data samples. The pipeline for evaluating the machine learning model can have some overlapping stages with the pipeline for labeling a set of data samples. For instance, the pipeline for evaluating a model learning model can include the first four stages of the pipeline for labeling the set of data samples, as discussed above, e.g., downloading or retrieving the data samples, validating the data samples, sending the data samples to labeling entities, receiving the generated labels. In addition, the pipeline for evaluating a machine learning model can include some extra stages. The extra stages are for evaluating the performance of the machine learning model based on the pipeline generated labels. For example, one extra stage can be inputting the data samples to the existing machine learning model to obtain machine learning model generated results. Another extra stage can be comparing the model generated results with the pipeline generated labels. Another extra stage can be determining the evaluation results based on the comparison. An example evaluation result can be the accuracy of the machine learning model. Another extra stage can be reporting the evaluation results to the client device.

In some implementations, e.g., related to the example of evaluating the performance of an existing machine learning model, the pipeline generation system can receive configuration data that identifies the input data, identifies the one or more data processing parameters, and identifies the machine learning model. The existing machine learning model can be a previously trained model that is used to label data samples. The pipeline generation system can select one or more extra data processing stages to evaluate the performance of the machine learning model. For example, the pipeline generation system can select one or more stages that provide the input data to the machine learning model, compare output data of the machine learning model with data generated by another system, e.g., in the pipeline processing system, and generate metrics about the machine learning model's processing of the input data based on a result of the comparison.

For instance, one stage of the selected stages can provide the input data to the machine learning model and execute the machine learning model to obtain output data. The output data can be labels generated by the machine learning model for the input data. One stage of the selected stages can compare the output data of the machine learning model with data generated in an earlier stage, such as the labels obtained from the labeling entity. Based on the comparison, one stage of the selected stages can generate metrics about the machine learning model. For example, the metrics can be the accuracy of the machine learning model based on whether the machine learning model generated labels match the labels of the earlier stage and the percentage of the matching labels.

In some implementations, the pipeline generation system can generate the data processing pipeline that includes at least one stage that will present a user interface to enable a person to select a user interface element, e.g., as part of a human-in-the-loop pipeline. For example, the data processing pipeline can include a stage that presents a user interface and requests the person to select a value from a list of predetermined options. In some example, the user interface can include a drop-down list, a radio button, a set of check boxes, and the like, that include a set of predetermined options for the person to choose. For example, for the task request of labeling a set of data samples, the user interface can request a person to select one or more topics from a list of predetermined topics.

At step 310, the pipeline generation system can cause, using the data processing pipeline, the one or more subsystems of the pipeline processing system to perform the processing steps defined by the data processing pipeline to generate the output data from the input data according to the one or more data processing parameters by sending one or more messages to the one or more subsystems in the pipeline processing system. The messages can include instructions that cause the receiving system to perform actions defined in the data processing pipeline.

After generating the data processing pipeline, the pipeline generation system can communicate with the pipeline processing system over one or more networks to cause the subsystems of the data processing system to process the generated pipeline. In some implementations, the different stages included in the data processing pipeline can be processed by different subsystems of the pipeline processing system.

In some implementations, the pipeline generation system can send the input data and the one or more data processing parameters to the pipeline processing system. The pipeline processing system can process the different stages of the data processing pipeline. For example, the pipeline processing system can process the input data according to the one or more parameters to generate output data. The pipeline processing system can return the output data to the client devices. In some implementations, the pipeline processing system can return the output data to the pipeline generation system. The pipeline generation system can send the output to the client device.

In some implementations, the pipeline processing system can select or filter quality data from the output data, and return the quality data to the client device. For example, the output data can include a label and a confidence value that indicates a likelihood that the label is an accurate label for the corresponding input data. The pipeline processing system can select the output data with a confidence value satisfying a threshold as the quality data. In some implementations, the threshold can be included in the one or more parameters.

In some implementations, the pipeline generation system can store both data samples and labels centrally, in compliance with privacy and data protection (PDP) practice and make the data samples and labels easily discoverable for reuse. In some implementations, the pipeline generation system can delete output data automatically after a pre-configured retention period to keep the output data compliant with the PDP policies. The pipeline generation system can provide users, e.g., customers, agnostic functionality like label quality measurement and PDP compliance while requiring minimal additional effort from users.

The order of steps in the process 300 described above is illustrative only, and can be performed in different orders. In some implementations, the process 300 can include additional steps, fewer steps, or some of the steps can be divided into multiple steps.

In some implementations, the pipeline generation system can cause the pipeline processing system to process part of the input data. For example, the pipeline generation system can receive configuration data for the data processing pipeline that will create one or more labels for the input data given the one or more data processing parameters. The pipeline generation system can determine, using a type of the configuration data, whether the system has a machine learning model that was trained to create labels for the input data. In response to determining that the system has a machine learning model that was trained to create labels for the input data, the pipeline generation system can provide the input data to the machine learning model to cause the machine learning model to create, for each set of the input data, a label and a confidence value that indicates a likelihood that the label is an accurate label for the corresponding set of the input data. In some example, the machine learning model can be located in another system that is different from the pipeline generation system. The configuration data can include the location of the machine learning model. The pipeline generation system can provide the input data to the machine learning model based on the location of the machine learning model.

The pipeline generation system can receive, from the machine learning model, labeled data that includes, for each set of the input data, the label and the confidence value. The pipeline generation system can select, from the input data, one or more sets of the input data that have corresponding confidence values that do not satisfy a threshold confidence value. The pipeline generation system can provide, to a subsystem from the pipeline processing system, the one or more sets of the input data that having corresponding confidence values that do not satisfy the threshold confidence value to cause the subsystem to create labels for the one or more sets of the input data.

Because there is a machine learning model trained for the task of labeling the input data, the pipeline generation system can use the machine learning model to create labels for the input data. Based on the confidence values of the labeled data, the pipeline generation system can select a subset of the input data for the data processing pipeline to process. The selected subset of the input data may not have a label that satisfies an accuracy threshold. The pipeline generation system can send such a subset of the input data to the data processing pipeline, so that the pipeline processing system can create labels, e.g., that are likely more accurate, for such subset of the input data. The other input data, created by the machine learning model, that have labels that satisfy the accuracy threshold are not provided to the pipeline processing system. As a result, only a subset of the input data are provided to the pipeline processing system for processing, which can reduce the cost, necessary computational resources, or both, for the task improve label accuracy, reduce computation time, e.g., by using the machine learning model for an initial labelling pass, or a combination of these.

In some implementations, the pipeline generation system can select a plurality of subsystems in the pipeline processing system for processing the input data. The pipeline generation system can receive the configuration data that identifies the input data, identifies the one or more data processing parameters, and identifies one or more types of subsystems in the pipeline processing system that will process the input data. For example, the pipeline generation system can receive a task request for labeling the input data. The configuration data can include the types of the subsystems for labeling the input data, such as expert system or non-expert system. In some examples, the configuration data can include a percentage of the input data for each type of the systems. For instance, the configuration data can specify that 40% of the input data should be labeled by an expert system, 60% of the input data should be labeled by a non-expert system. In some implementations, the cost, necessary computational resources, or both, for different types of the subsystems can be different. For example, the cost, necessary computational resources, or both, of the service provided by the expert system may be more expensive. The user can issue a task request based on the financial consideration and the tradeoff between the cost and the quality of the service.

The pipeline generation system can select, from the subsystems in the pipeline processing system, one or more subsystems using the one or more types of the subsystems that will process the input data. For example, the pipeline generation system can select a particular expert system, e.g., from multiple expert systems, and a particular non-expert system, e.g., from multiple non-expert systems, to process the corresponding input data. In some examples, the pipeline generation system can select a combination of an expert system and a non-expert system instead of selecting subsystems of only one type or the other.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an Hypertext Markup Language (HTML) page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims, described in the specification, or depicted in the figures can be performed in a different order and still achieve desirable results. In some cases, multitasking and parallel processing may be advantageous.

What is claimed is:

1. A system comprising one or more computers and one or more storage devices on which are stored instructions that are operable, when executed by the one or more computers, to cause the one or more computers to perform operations comprising:
receiving configuration data that identifies a) input data to be processed by a pipeline processing system that includes one or more subsystems and b) one or more data processing parameters according to which the pipeline processing system will process the input data;
accessing two or more templates, wherein each template includes a set of data processing stages that each define a data type and one or more data processing steps for a respective subsystem, from the one or more subsystems, to perform on respective data of the data type;
after receiving the configuration data, selecting, from the two or more templates and using the configuration data, one or more specific templates that have a plurality of data processing stages, wherein the one or more specific templates are selected according to the configuration data;
generating, using the configuration data and the one or more specific templates, the data processing pipeline, wherein the data processing pipeline is a pipeline specification that i) includes the plurality of data processing stages in an order selected using the configuration data and ii) indicates, for at least some of the stages in the plurality of data processing stages, one or more processing steps for the respective subsystem from the one or more subsystems of the pipeline processing system to perform on respective data, associated with the input data, of the data type; and
causing, using the data processing pipeline, the one or more subsystems of the pipeline processing system to perform the processing steps defined by the data processing pipeline to generate the output data from the input data according to the one or more data processing parameters by sending one or more messages to the one or more subsystems.

2. The system of claim 1, wherein receiving the configuration data that identifies the one or more data processing parameters comprises receiving a parameter set identifier for the one or more data processing parameters.

3. The system of claim 2, wherein causing the one or more subsystems of the pipeline processing system to perform the processing steps defined by the data processing pipeline comprises sending the parameter set identifier to an initial subsystem from the one or more other subsystems in the data processing pipeline.

4. The system of claim 1, comprising selecting the order for the plurality of data processing stages using an input data type and an output data type identified by the configuration data.

5. The system of claim 1, wherein receiving the configuration data that identifies the input data comprises receiving one or more query parameters that, when run on a database, return the input data.

6. The system of claim 1, wherein:
accessing the templates comprises retrieving, from memory, a data processing pipeline template that includes one or more variables; and
generating the data processing pipeline comprises configuring the one or more variables included in the data processing pipeline template using the configuration data to generate the data processing pipeline.

7. The system of claim 1, wherein:
selecting the templates comprises selecting, from a plurality of data processing pipeline templates and using the configuration data, a single data processing pipeline template that defines the entire data processing pipeline; and
generating the data processing pipeline comprises configuring the single data processing pipeline template using the configuration data to generate the entire data processing pipeline.

8. The system of claim 1, wherein selecting the templates comprises selecting, from two or more data processing pipeline stages and using the configuration data, one or more data processing pipeline stages that together form the data processing pipeline.

9. The system of claim 8, wherein:
receiving the configuration data comprises receiving the configuration data that identifies the input data, identifies the one or more data processing parameters, and identifies a machine learning model; and
selecting the one or more data processing pipeline stages comprises:
selecting one or more stages for the data processing pipeline that provide, to the machine learning model, the input data, compare output data of the machine learning model with data generated by one of the one or more other systems, and generate metrics about the machine learning model's processing of the input data using a result of the comparison.

10. The system of claim 1, wherein generating the data processing pipeline comprises generating the data processing pipeline that comprises at least one stage that will present a user interface to enable a user to select a user interface element.

11. The system of claim 1, wherein selecting the templates comprises selecting, using data other than the configuration data, the templates.

12. The system of claim 11, wherein selecting the templates using data other than the configuration data comprises selecting the templates that includes at least one data validation stage that validates the input data for the one or more data processing parameters.

13. The system of claim 1, wherein:
receiving the configuration data for the data processing pipeline comprises receiving the configuration data for the data processing pipeline that will create one or more labels for the input data given the one or more data processing parameters; and
causing the one or more subsystems of the pipeline processing system to perform the processing steps defined by the data processing pipeline comprises:
determining, using a type of the configuration data, whether the system has a machine learning model that was trained to create labels for the input data that includes a plurality of sets;
in response to determining that the system has a machine learning model that was trained to create labels for the input data, providing, to the machine learning model, the input data to cause the machine learning model to create, for each input data set from the plurality of sets, a label and a confidence value that indicates a likelihood that the label is an accurate label for the corresponding input data set;
receiving, from the machine learning model, labeled data that includes, for each input data set, the label and the confidence value;
selecting, from the plurality of sets, one or more sets of the input data that have corresponding confidence values that do not satisfy a threshold confidence value; and
providing, to a first subsystem from the one or more subsystems, the one or more sets of the input data that have corresponding confidence values that do not satisfy the threshold confidence value to cause the first subsystem to create labels for the one or more sets of the input data.

14. The system of claim 1, wherein:
receiving the configuration data comprises receiving the configuration data that identifies the input data, identifies the one or more data processing parameters, and identifies one or more types of subsystems for the one or more subsystems that will process the input data; and
causing the one or more subsystems of the pipeline processing system to perform the processing steps defined by the data processing pipeline comprises:
selecting, from a plurality of subsystems and using the one or more types of subsystems, the one or more subsystems that will process the input data.

15. A non-transitory computer storage medium encoded with instructions that, when executed by one or more computers, cause the one or more computers to perform operations comprising:
receiving configuration data that identifies a) input data to be processed by a pipeline processing system that includes one or more subsystems and b) one or more data processing parameters according to which the pipeline processing system will process the input data;
accessing two or more templates, wherein each template includes a set of data processing stages that each define a data type and one or more data processing steps for a respective subsystem, from the one or more subsystems, to perform on respective data of the data type;
after receiving the configuration data, selecting, from the two or more templates and using the configuration data, one or more specific templates that have a plurality of data processing stages, wherein the one or more specific templates are selected according to the configuration data;
generating, using the configuration data and the one or more specific templates, the data processing pipeline, wherein the data processing pipeline is a pipeline specification that i) includes the plurality of data processing stages in an order selected using the configuration data and ii) indicates, for at least some of the stages in the plurality of data processing stages, one or more processing steps for the respective subsystem from the one or more subsystems of the pipeline processing system to perform on respective data, associated with the input data, of the data type; and
causing, using the data processing pipeline, the one or more subsystems of the pipeline processing system to perform the processing steps defined by the data processing pipeline to generate the output data from the input data according to the one or more data processing parameters by sending one or more messages to the one or more subsystems.

16. The non-transitory computer storage medium of claim 15, wherein:
selecting the templates comprises selecting, from two or more data processing pipeline stages and using the configuration data, one or more data processing pipeline stages that together form the data processing pipeline;
receiving the configuration data comprises receiving the configuration data that identifies the input data, identifies the one or more data processing parameters, and identifies a machine learning model; and
selecting the one or more data processing pipeline stages comprises:
selecting one or more stages for the data processing pipeline that provide, to the machine learning model, the input data, compare output data of the machine learning model with data generated by one of the one or more other systems, and generate metrics about the machine learning model's processing of the input data using a result of the comparison.

17. The non-transitory computer storage medium of claim 15, wherein:
receiving the configuration data for the data processing pipeline comprises receiving the configuration data for the data processing pipeline that will create one or more labels for the input data given the one or more data processing parameters; and
causing the one or more subsystems of the pipeline processing system to perform the processing steps defined by the data processing pipeline comprises:
determining, using a type of the configuration data, whether the system has a machine learning model that was trained to create labels for the input data that includes a plurality of sets;
in response to determining that the system has a machine learning model that was trained to create labels for the input data, providing, to the machine learning model, the input data to cause the machine learning model to create, for each input data set from the plurality of sets, a label and a confidence value that indicates a likelihood that the label is an accurate label for the corresponding input data set;
receiving, from the machine learning model, labeled data that includes, for each input data set, the label and the confidence value;
selecting, from the plurality of sets, one or more sets of the input data that have corresponding confidence values that do not satisfy a threshold confidence value; and
providing, to a first subsystem from the one or more subsystems, the one or more sets of the input data that have corresponding confidence values that do not satisfy the threshold confidence value to cause the first subsystem to create labels for the one or more sets of the input data.

18. A computer-implemented method comprising:
receiving configuration data that identifies a) input data to be processed by a pipeline processing system that includes one or more subsystems and b) one or more data processing parameters according to which the pipeline processing system will process the input data;
accessing two or more templates, wherein each template includes a set of data processing stages that each define a data type and one or more data processing steps for a respective subsystem, from the one or more subsystems, to perform on respective data of the data type;
after receiving the configuration data, selecting, from the two or more templates and using the configuration data, one or more specific templates that have a plurality of data processing stages, wherein the one or more specific templates are selected according to the configuration data;
generating, using the configuration data and the one or more specific templates, the data processing pipeline, wherein the data processing pipeline is a pipeline specification that i) includes the plurality of data processing stages in an order selected using the configuration data and ii) indicates, for at least some of the stages in the plurality of data processing stages, one or more processing steps for the respective subsystem from the one or more subsystems of the pipeline processing system to perform on respective data, associated with the input data, of the data type; and
causing, using the data processing pipeline, the one or more subsystems of the pipeline processing system to perform the processing steps defined by the data processing pipeline to generate the output data from the input data according to the one or more data processing parameters by sending one or more messages to the one or more subsystems.

19. The computer-implemented method of claim 18, wherein:
selecting the templates comprises selecting, from two or more data processing pipeline stages and using the configuration data, one or more data processing pipeline stages that together form the data processing pipeline;
receiving the configuration data comprises receiving the configuration data that identifies the input data, identifies the one or more data processing parameters, and identifies a machine learning model; and
selecting the one or more data processing pipeline stages comprises:
selecting one or more stages for the data processing pipeline that provide, to the machine learning model, the input data, compare output data of the machine learning model with data generated by one of the one or more other systems, and generate metrics about the machine learning model's processing of the input data using a result of the comparison.

20. The computer-implemented method of claim 18, wherein:
receiving the configuration data for the data processing pipeline comprises receiving the configuration data for the data processing pipeline that will create one or more labels for the input data given the one or more data processing parameters; and
causing the one or more subsystems of the pipeline processing system to perform the processing steps defined by the data processing pipeline comprises:
determining, using a type of the configuration data, whether the system has a machine learning model that was trained to create labels for the input data that includes a plurality of sets;
in response to determining that the system has a machine learning model that was trained to create labels for the input data, providing, to the machine learning model, the input data to cause the machine learning model to create, for each input data set from the plurality of sets, a label and a confidence value that indicates a likelihood that the label is an accurate label for the corresponding input data set;
receiving, from the machine learning model, labeled data that includes, for each input data set, the label and the confidence value;
selecting, from the plurality of sets, one or more sets of the input data that have corresponding confidence values that do not satisfy a threshold confidence value; and
providing, to a first subsystem from the one or more subsystems, the one or more sets of the input data that have corresponding confidence values that do not satisfy the threshold confidence value to cause the first subsystem to create labels for the one or more sets of the input data.
